(19) United States
(12) Patent Application Publication
(10) Pub. No.: US 2015/0350982 A1
(43) Pub. Date: Dec. 3, 2015

(54) METHOD AND APPARATUS FOR IMPROVING VOICE AND DATA COMMUNICATIONS IN A WIRELESS NETWORK

(71) Applicant: QUALCOMM Incorporated, San Diego, CA (US)

(72) Inventors: Bhaskara Viswanadham BATCHU, Hyderabad (IN); Soumen MITRA, Hyderabad (IN); Rashid Ahmed Akbar ATTAR, San Diego, CA (US); Jun HU, San Diego, CA (US)

(73) Assignee: QUALCOMM Incorporated, San Diego, CA (US)

(21) Appl. No.: 14/289,414

(22) Filed: May 28, 2014

(51) Int. Cl. H04W 36/14; H04W 24/10; H04L 12/26; H04W 36/00

(52) U.S. Cl. CPC H04W 36/14; H04W 36/0083; H04W 24/10; H04L 43/0864

(57) ABSTRACT

Methods and apparatuses relating to wireless communication of a user equipment (UE) are provided including initiating an access procedure for a first radio access technology (RAT) and tuning a receiver to a second RAT for a duration during the access procedure for the first RAT. The methods and apparatuses further include receiving a paging signal via the second RAT during the duration, and tuning the receiver to the first RAT following the duration to continue the access procedure for the first RAT. Other aspects, embodiments, and features are also claimed and described.

### TECHNICAL FIELD

The technology discussed below relates generally to wireless communication systems, and more particularly, to using tune-away strategies to improve voice and data communications in a wireless network.

### BACKGROUND

Wireless communication networks are widely deployed to provide various communication services such as telephony, video, data, messaging, broadcasts, and so on. Some devices operable to communicate over such networks can communicate using a plurality of different radio access technologies (RAT) to access the networks. For example, a multi-subscriber identity module (SIM) or multi-standby device can communicate using multiple RATs over a single or plural transceivers. In some examples, deadlock situations can arise due to radio frequency (RF) resource contention among the multiple RATs where the device reserves resources for communicating using the RATs based on priorities specified for RAT operations. In one specific example, in high data rate (HDR) networks (e.g., 1× evolution data optimized (1×EVDO)), if HDR requests RF resources with lower priority for an access mode than for another network (e.g., a voice network, such as GSM), the device may not be able to perform access procedures for HDR as the other network (GSM) may continuously use the RF resources (e.g., transceiver chain) for higher priority operations. In another example, if the device increases HDR priority for performing the access procedure, the other network (e.g., GSM) may starve to get RF resources, which can lead to the device missing one or more paging signals transmitted by the other network during the HDR access mode. In either case, one or the other RAT is negatively impacted.

### BRIEF SUMMARY OF SOME EXAMPLES

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication of a user equipment (UE) is provided. The method includes initiating an access procedure for a first radio access technology (RAT), and tuning a receiver to a second RAT for a duration during the access procedure for the first RAT. The method further includes receiving a paging signal via the second RAT during the duration, and tuning the receiver to the first RAT following the duration to continue the access procedure for the first RAT.

In another aspect, an apparatus for wireless communication of a UE is provided. The apparatus includes a multi-RAT communicating circuit having various components. The various components can include an access procedure circuit configured for initiating an access procedure for a first RAT, a strategic tune-away circuit configured for tuning a receiver to a second RAT for a duration during the access procedure for the first RAT, and a signal processing circuit configured for receiving a paging signal via the second RAT during the duration. The strategic tune-away circuit is further configured for tuning the receiver to the first RAT following the duration to continue the access procedure for the first RAT.

In still a further aspect, a computer program product, stored on a non-transitory computer readable medium, for wireless communication of a UE is provided. The computer program product includes code for causing at least one computer to initiate an access procedure for a first RAT, code for causing the at least one computer to tune a receiver to a second RAT for a duration during the access procedure for the first RAT, and code for causing the at least one computer to receive a paging signal via the second RAT during the duration. The code for causing the at least one computer to tune tunes the receiver to the first RAT following the duration to continue the access procedure for the first RAT.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram illustrating exemplary aspects of communicating with multiple radio access technologies (RAT) in a wireless communication system;

FIG. 2 is a flow diagram illustrating an exemplary method for performing strategic tune-away from a first RAT to a second RAT;

FIG. 3 is a schematic diagram illustrating exemplary aspects of determining scenarios for performing strategic tune-away;

FIG. 4 is a flow diagram illustrating an exemplary method for performing strategic tune-away from a first RAT to a second RAT during an access procedure;

FIG. 5 is a flow diagram illustrating an exemplary method for performing strategic tune-away from a first RAT to a second RAT during an access procedure;

FIG. 6 is a flow diagram illustrating an exemplary method for performing strategic tune-away from a first RAT to a second RAT based on priority inversion;

FIG. 7 is a flow diagram illustrating an exemplary method for performing strategic tune-away from a first RAT to a second RAT based on a persistence test;

FIG. 8 is a flow diagram illustrating an exemplary method for performing strategic tune-away from a first RAT to a second RAT based on uplink power headroom;

FIG. 9 illustrates example access probe transmissions and time intervals for performing strategic tune-away;

FIG. 10 is a block diagram illustrating an example of a hardware implementation for an apparatus employing a processing system to perform the functions described herein;

FIG. 11 is a block diagram conceptually illustrating an example of a telecommunications system including a user equipment (UE) configured to perform the functions described herein;

FIG. 12 is a conceptual diagram illustrating an example of an access network for use with a UE configured to perform the functions described herein;

FIG. 13 is a conceptual diagram illustrating an example of a radio protocol architecture for the user and control planes for a base station and/or a UE configured to perform the functions described herein; and

FIG. 14 is a block diagram conceptually illustrating an example of a Node B in communication with a UE in a telecommunications system configured to perform the functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Described herein are various aspects related to using strategic tune-away during an access procedure for a first radio access technologies (RAT) in an attempt to facilitate communicating with a second RAT. For example, there can be certain durations during the access procedure during which communications are known to not be received from the first RAT, and a receiver can be tuned away from the first RAT at least during such durations to facilitate receiving signals from a node of the second RAT. For example, when an access procedure for the first RAT is initiated by transmitting an access probe, the next communication received for the first RAT can be an acknowledgement of the access probe, which is not received at least until after a round-trip time (RTT) delay. Thus, a receiver can be tuned away from the first RAT to the second RAT during at least a portion of the RTT delay after sending the access probe. Other messages can have similar delays, and thus the receiver can be tuned away while awaiting receipt of the other messages of the access probe procedure.

In additional examples, other conditions during the access procedure can be detected or determined, such as priority inversion of other RATs, failure of a persistence test for access probe transmission, power headroom exceeding a threshold, etc., which can additionally relate to not receiving transmissions on the first RAT for a duration, during which the receiver can be tuned to the second RAT. Moreover, in some examples, tuning the receiver can be limited in certain scenarios to minimize potential negative side effects to the first RAT access procedure. In any case, by allowing tune-away to the second RAT during the access procedure for the first RAT to receive paging signals or other signals in the second RAT, negative effects to the second RAT can be mitigated, and a corresponding device can communicate with both RATs during the access procedure.

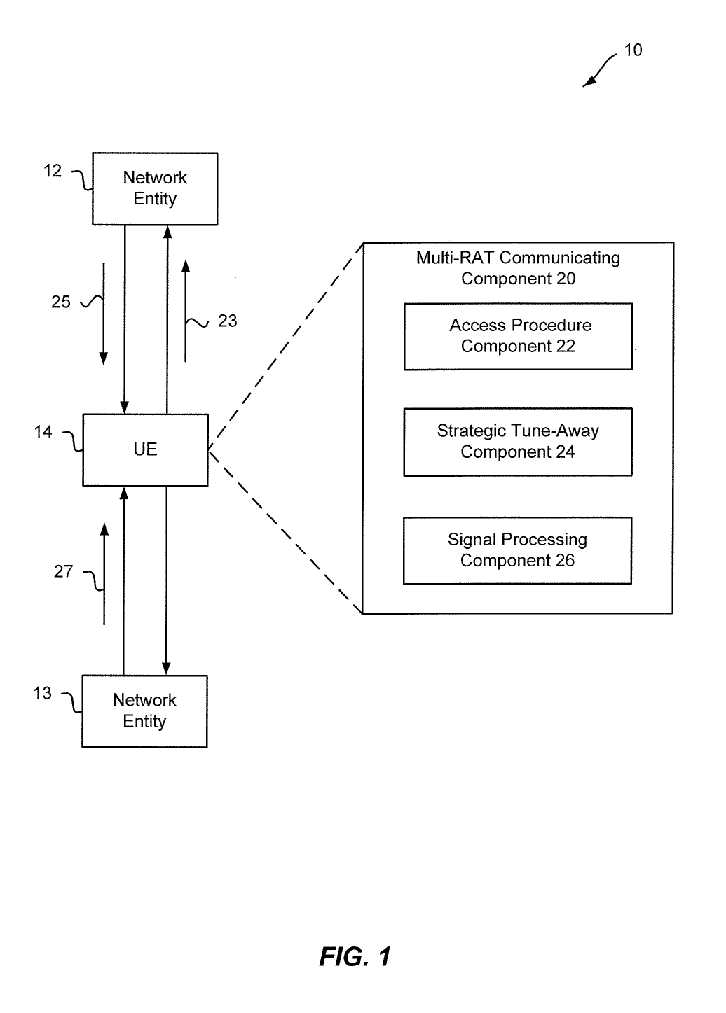

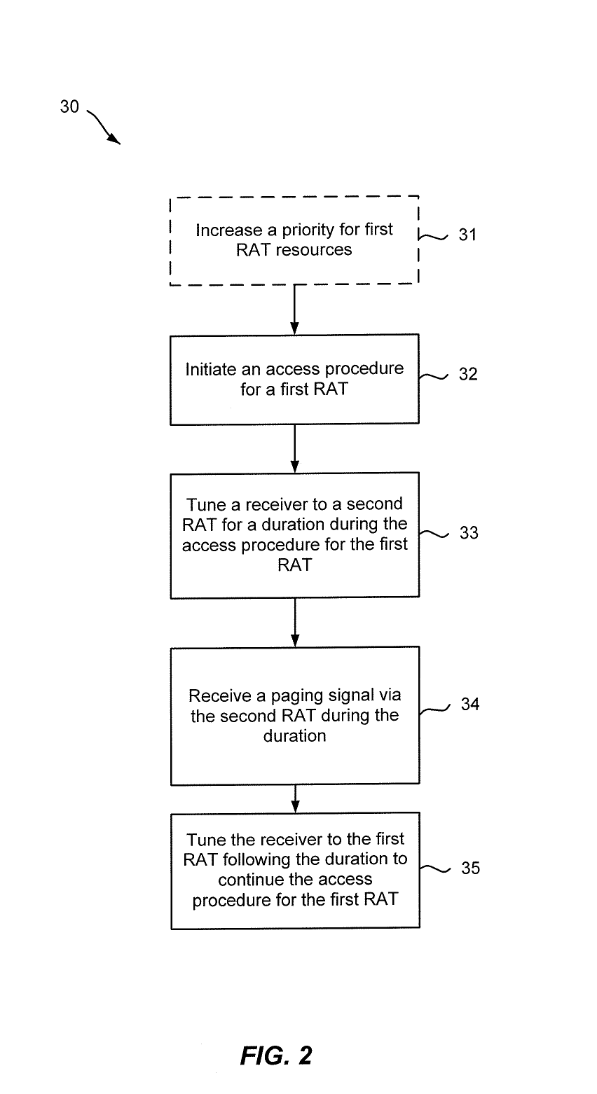

Referring to FIGS. 1 and 2, aspects of the present apparatus and method are depicted with reference to one or more components and one or more methods that may perform the actions or functions described herein. Although the operations described below in FIG. 2 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In FIG. 1, in one aspect of the present apparatus and method, a wireless communication system 10 is configured to perform wireless communications between network entity 12 and UE 14. The wireless communication system 10 may be configured to support communications between a number of users or UEs. FIG. 1 illustrates a manner in which network entity 12 communicates with UE 14. The wireless communication system 10 can be configured for downlink message transmission from network entity 12 to UE 14 or uplink message transmission from UE 14 to network entity 12, as represented by the up/down arrows between network entity 12 and UE 14. The wireless communication system 10 may also be configured to support communications between UE 14 and another network entity 13, which can include uplink and downlink communications indicated by the up/down arrows between UE 14 and network entity 13.

It is to be appreciated, for example, that network entities 12 and 13 can communicate using different RATs, and thus UE 14 can communicate with the network entities 12 and 13 using the respective RATs. Network entities 12 and 13 can be nodes of the same wireless network, nodes of different wireless networks, etc. In addition, in an example, network entities 12 and 13 can be the same network entity capable of communicating using the multiple RATs. For example, the RATs can correspond to different radio frequency (RF) resources, time resources, or other resources, and thus the UE 14 can communicate using the multiple RATs by varying RF resources, time resources, etc. used to communicate. In an example, as described further herein, UE 14 can include a single receiver or multiple receivers or related resources, antennas, etc. configured to communicate with one or more of the network entities 12 and 13 using one or more of the RATs at a given point in time.

FIG. 2 illustrates a method 30 for strategically tuning a receiver, during an access procedure for a first RAT, to a second RAT. UE 14 (FIG. 1) includes a multi-RAT communicating component 20 to facilitate tuning the receiver to communicate with the first and second RATs. Method 30 may initially optionally include, at Block 31, increasing a priority for first RAT resources to ensure resources are available for initiating an access procedure, such as RF resources of a transmitter and/or receiver chain. For example, multi-RAT communicating component 20 can increase the priority for resources (e.g., over a priority for resources of the second RAT) to ensure that the access procedure can be initiated over other procedures related to the second RAT. This can improve accessibility for the first RAT, and additional functions described herein improve accessibility for the second RAT during the first RAT access procedure. Tuning the receiver may include, for example, tuning to RF resources of the second RAT (e.g., to a frequency thereof, during a time related to second RAT communications, etc.).

Method 30 also includes, at Block 32, initiating an access procedure for a first RAT. For example, the access procedure can include a procedure to initiate an ACCESS mode in high data rate (HDR) network, such as 1× evolution data optimized (1×EVDO), as described further herein, and/or other access procedures, such as a random access procedure in LTE, etc. Multi-RAT communicating component 20 includes an access procedure component 22 for performing the access procedure using a first RAT. For example, access procedure component 22 can initiate the access procedure with network entity 12 using the first RAT. Initiating the access procedure can include transmitting an access probe 23 to the network entity 12. In an example, the access probe 23 can include an access preamble (e.g., a random access preamble) or other request to acquire a dedicated channel for accessing a wireless network via network entity 12 over the first RAT.

Method 30 further includes, at Block 33, tuning a receiver a second RAT for a duration during the access procedure for the first RAT. Multi-RAT communicating component 20 includes a strategic tune-away component 24 for tuning a receiver of the UE 14 to the second RAT during strategic time instances in the access procedure (e.g., when awaiting a response to a transmission). For example, the second RAT may include a GSM or similar network that provides voice services, in the example above where the first RAT is an HDR RAT, such as 1×EVDO. In an example, strategic tune-away component 24 can tune the receiver in one or more durations during the access procedure based at least in part on detecting or determining certain conditions or transmissions related to the access procedure. In an example, when access procedure component 22 sends the access probe 23 to network entity 12, strategic tune-away component 24 can tune the receiver of the UE 14 to the second RAT for communicating with network entity 13 for a duration determined based on an RTT, and can tune the receiver of the UE 14 back to the first RAT at some time before or once the RTT has expired, after which access procedure component 22 may receive an access acknowledgement channel (ACAck) 25 from network entity 12.

In this example, strategic tune-away component 24 may measure the RTT based on observing a timing difference between a time when signals sent by the network entity 12 (which may be indicated in the signals) and when the signals are received by UE 14. In another example, network entity 12 may provide an indication of the RTT to UE 14, which may be based on signals from UE 14 similarly observed at network entity 12. In either case, strategic tune-away component 24 can determine the duration for the tune-away to be substantially equal to the MT, equal to a time between a current time and the access probe transmission time subtracted from the RTT, or some other value based on the RTT (e.g., a fixed difference from the RTT, a fraction of the RTT, etc.). In an additional or alternative example, strategic tune-away component 24 can tune the receiver to the second RAT based on detecting receipt of the ACAck 25 for a predetermined time delay between receipt of ACAck 25 and a traffic channel complete acknowledgement (TCCAck), which can also be indicated at signal 25, after which strategic tune-away component 24 can tune the receiver back to the first RAT. Moreover, in an example, strategic tune-away component 24 can tune a receiver chain to the second RAT as the access probe is transmitted by the UE 14 over the transmitter chain (e.g., at the beginning of the access probe transmission or sometime during transmitting the access probe and/or one or more access probe sequences). Additional examples of durations during which the UE 14 can tune its receiver to the second RAT are described further herein.

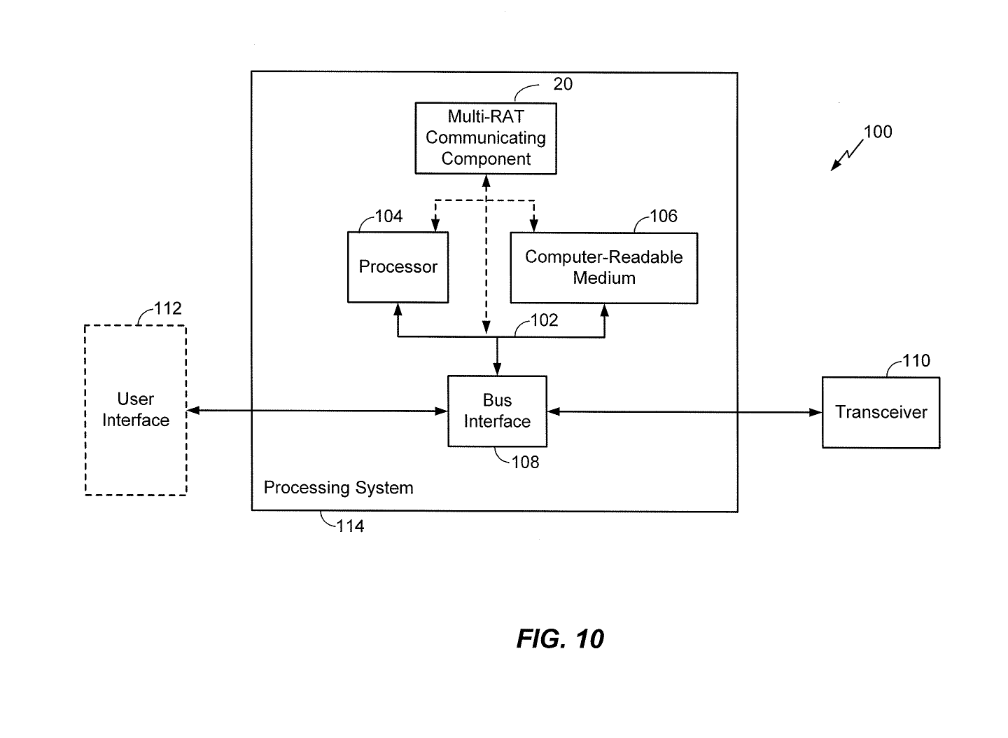

It is to be appreciated that tuning the receiver can include tuning a receiver portion of a transceiver (e.g., transceiver 110 in FIG. 10 below) to receive communications over the second RAT resources. This can include tuning the receiver to a frequency band operated by the second RAT, tuning the receiver to receive in certain time slots in a TDD system, and/or the like. Some transceivers that the UE 14 may employ may have separate transmitter and receiver resources, in which case tuning the receiver includes tuning the receiver resources while still allowing the transmitter to transmit over other resources. In this example, however, if a band incompatibility exists between the first and second RATs, transmission blanking can be applied at the transmitter to avoid interfering with receiving second RAT communications.

Method 30 also includes, at Block 34, receiving a paging signal via the second RAT during the duration. Multi-RAT communicating component 20 can include a signal processing component 26 for receiving the signals 27 from network entity 13 when tuned to the second RAT, which may include a paging signal. Signal processing component 26 can process the signal according to the second RAT to facilitate communicating using the second RAT. For example, where the signal is a paging signal, the paging signal may relate to an indication to switch to active mode communications in the second RAT (e.g., to receive a voice call). Signal processing component 26 may cause the UE 14 to perform some function based on the signal in this regard, such as switching to the active mode to communicate using the second RAT. Thus, multi-RAT communicating component 20 is able to receive signals 27 related to the second RAT during the access procedure for the first RAT.

Method 30 also includes, at Block 35, tuning the receiver to the first RAT following the duration to continue the access procedure for the first RAT. Thus, as described strategic tune-away component 24 can tune the receiver back to the first RAT following an RTT or other known or determined duration in continuing the access procedure over the first RAT. As described, in one example, strategic tune-away component 24 tunes the receiver to the second RAT after the access probe 23 is sent for a duration of an RTT, tunes the receiver back to the first RAT to receive the ACAck 25, tunes the receiver to the second RAT again for a period of time after receiving the ACAck 25, and tunes the receiver back to the first RAT after the period of time to receive the TCCAck 25. Thus, the first RAT, in one example, can include HDR (e.g., 1×EVDO), the access procedure can include UE 14 transitioning to an HDR ACCESS state (e.g., from an IDLE state or similar dormant state), and the second RAT can include GSM. It is to be appreciated, however, that similar concepts can be applied for access procedures of other RATs as well (e.g., LTE).

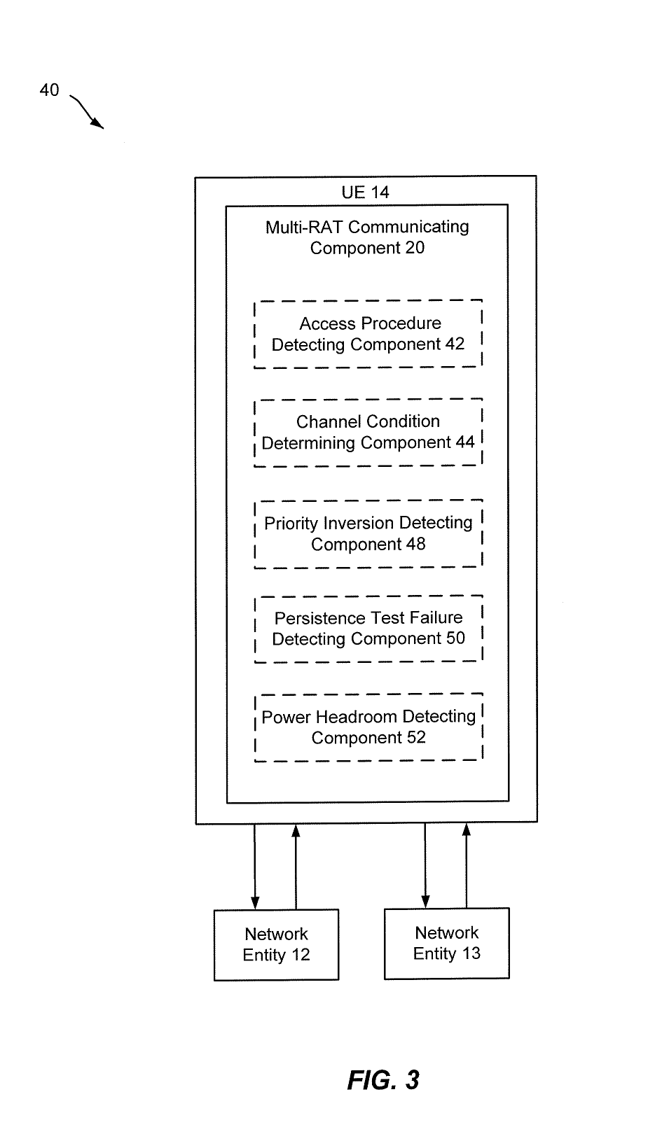

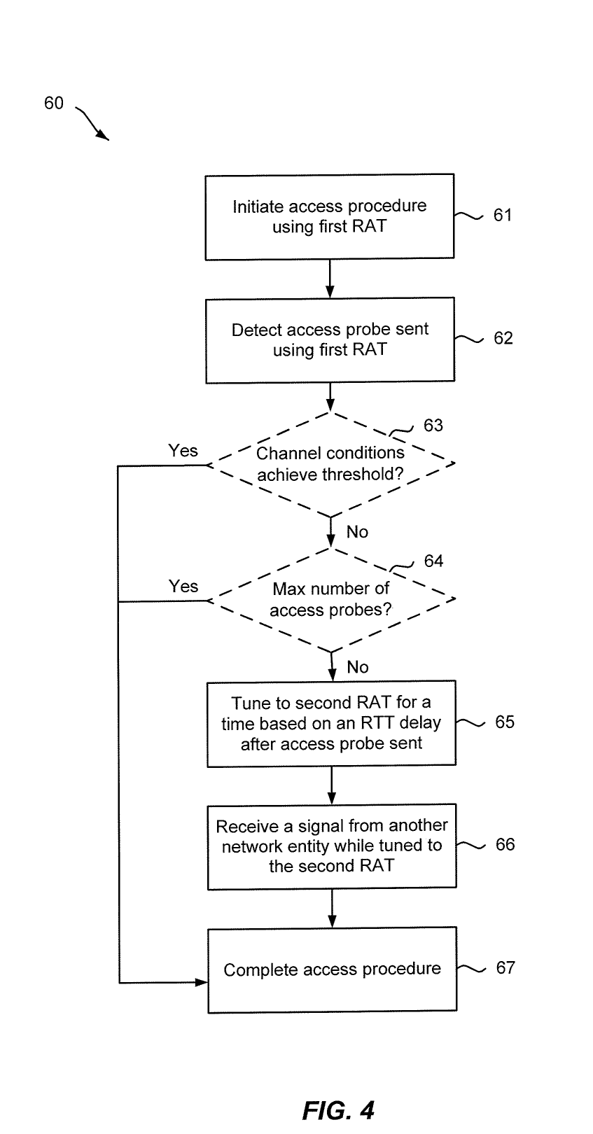

Referring to FIGS. 3-8, aspects of the present apparatus and method are depicted with reference to one or more components and various example methods that may perform the actions or functions described herein. Although the operations described below in FIGS. 4-8 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In FIG. 3, in one aspect of the present apparatus and method, a wireless communication system 40 is configured to include wireless communications between network entities 12/13 and UE 14, as described with respect to FIG. 1. UE 14 includes multi-RAT communicating component 20, as described above, which in addition to the components shown in FIG. 1, can also include various components for performing additional or alternative operations to determine opportunities for strategic tune-away, as described in conjunction with FIGS. 3-8.

FIG. 4 depicts an example method 60 for strategically tuning away from a first RAT during an access procedure to receive signals in a second RAT. Method 60 includes, at Block 61, initiating an access procedure using a first RAT. As described, UE 14 (FIG. 1) can include an access procedure component 22 for performing the access procedure with the first RAT, which may include transmitting one or more access probes to network entity 12 using the first RAT in an attempt to receive an acknowledgement of the access probe (e.g., an ACAck) and/or an indication that a traffic channel is established for UE 14 to communicate with the network entity 12 using the first RAT (e.g., a TCCAck).

Thus, method 60 can also include, at Block 62, detecting or determining an access probe sent using the first RAT. Multi-RAT communicating component 20 of the UE 14 (FIG. 3) may optionally include an access procedure detecting component 42 for detecting occurrence of the access probe transmission. For example, access procedure detecting component 42 can detect the access probe transmission by the UE 14 based on receiving an indication of transmitting the access probe from the access procedure component 22 (and/or from a related transmitter). In one example, a detected access probe transmission can include detecting a single access probe or sequence of multiple access probe transmissions (e.g., based on the RAT over which the access probes are transmitted).

Method 60 optionally includes, at Block 63, determining whether channel conditions achieve a threshold. In this example, multi-RAT communicating component 20 may optionally include a channel condition determining component 44 for determining the channel conditions and/or whether the conditions achieve the threshold. For example, channel condition determining component 44 can determine whether a signal-to-noise ratio (SNR), received signal strength indicator (RSSI), or similar metrics of radio or channel conditions achieves a threshold. The threshold can be preconfigured or otherwise provisioned to the UE 14, and can represent desired channel conditions for which the access procedure is expected to complete quickly (e.g., in a first access probe sequence), such that tune-away during the access procedure may not be needed to receive signals of the second RAT during the access procedure. In this regard, if the channel conditions achieve the threshold at Block 63, method 60 includes, at Block 67, completing the access procedure (e.g., via access procedure component 22) without performing tune-away. This can include first tuning back to the first RAT, as described above.

Where the channel conditions do not achieve the threshold at Block 63, method 60 optionally includes, at Block 64, additionally determining if a maximum number of access probes have occurred. Access procedure detecting component 42, in this regard, can optionally track a number of access probes to determine if a maximum number of access probes have occurred. Determining a maximum number of access probes can relate to determining whether a number of access probes transmitted by access procedure component 22 multiplied by a number of sequences of the access probes achieves a threshold. In another example, determining a maximum number of access probes can include determining that a maximum number of sequences except a last access probe sequence have been transmitted by access procedure component 22. Thus, if the maximum number of access probes or access probe sequences have been transmitted, as determined at Block 64, the access procedure can be completed at Block 67 without performing tune-away.

For example, where the maximum number of access probes relates to a number of probes multiplied by a number of sequences, determining whether the maximum number of access probes or sequences have been transmitted before tuning the receive to the second RAT can ensure that if the access procedure is impacted by allowing tune-away for previous probe transmissions, subsequent probe transmissions by access procedure component 22 may be transmitted successfully. Where the maximum number of access probes relates to whether a number of access probes sequences except for a last sequence have been transmitted (e.g., number of possible access probe sequences—1), determining whether the maximum number of access probes or sequences have been transmitted before tuning the receive to the second RAT can ensure that even if the previous access probe transmissions are impacted by tune-away, the access procedure component 22 can transmit the last access probe sequence without being affected by tune-away.

Where the maximum number of access probes has not been transmitted at Block 64, method 60 includes, at Block 65, tuning to a second RAT for a time based on an RTT delay after the access probe is sent. As described, strategic tune-away component 24 can tune the receiver for the RTT delay, where the RTT delay is determined from parameters received from network entity 12, parameters preconfigured or otherwise provisioned to UE 14, and/or the like. Method 60 also includes, at Block 66, receiving a signal from another network entity while tuned to the second RAT. As described, signal processing component 26 can be configured to receive signals from network entity 13 using the second RAT during the tune-away. Method 60 also includes, at Block 67, completing the access procedure, as described.

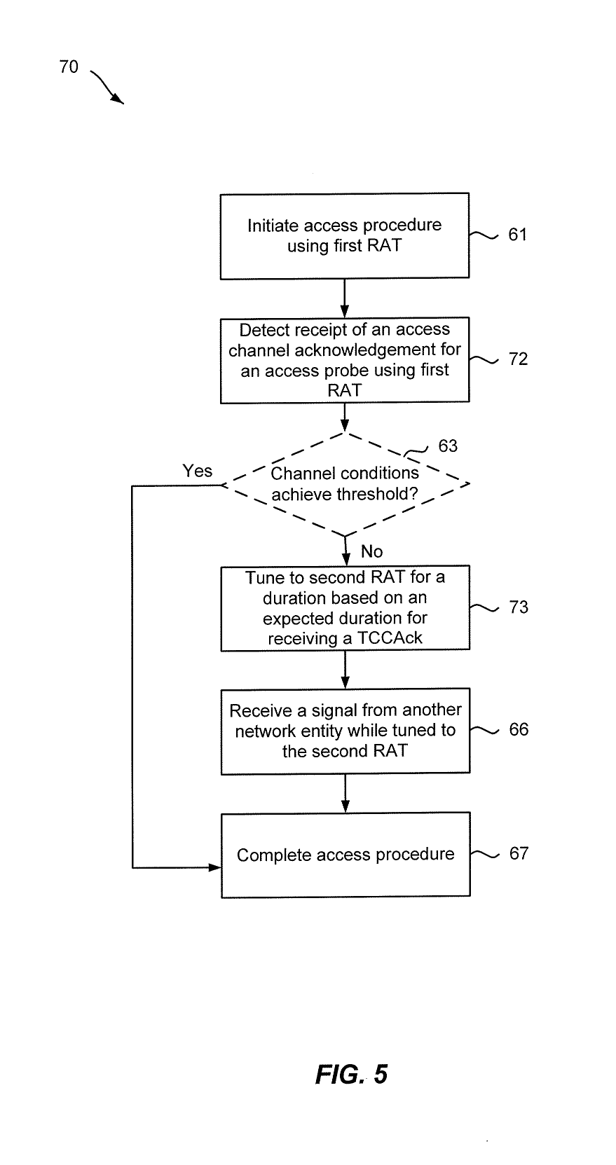

FIG. 5 illustrates an example method 70 for performing strategic tune-away to receive signals in a second RAT during an access procedure of a first RAT. Method 70 includes, at Block 61, initiating an access procedure using the first RAT, as described above. UE 14 can include an access procedure component 22 for initiating the access procedure in this regard.

Method 70 also includes, at Block 72, detecting receipt of an access channel acknowledgement (ACAck) for an access probe using a first RAT. Access procedure detecting component 42 can detect receipt of the ACAck from network entity 12 as part of the access procedure. This can include receiving an indication that the ACAck has been received from a receiver of the UE 14 or from another component.

Method 70 optionally includes, at Block 63, determining whether channel conditions achieve a threshold. As described with respect to FIG. 4, channel condition determining component 44 can determine whether the channel conditions achieve the threshold, and if so, method 70 includes, at Block 67, completing the access procedure without performing tune-away.

If channel conditions do not achieve the threshold at Block 63, however, method 70 includes, at Block 73, tuning to a second RAT for a duration based on an expected duration for receiving a TCCAck. For example, as described, strategic tune-away component 24 can tune to the second RAT for the duration, and can determine the duration based on a preconfigured duration and/or a provisioned duration. Method 70 also includes, at Block 66, receiving a signal from another network entity while tuned to the second RAT. As described, signal processing component 26 can be configured to receive signals from network entity 13 using the second RAT during the tune-away. Method 70 also includes, at Block 67, completing the access procedure, as described.

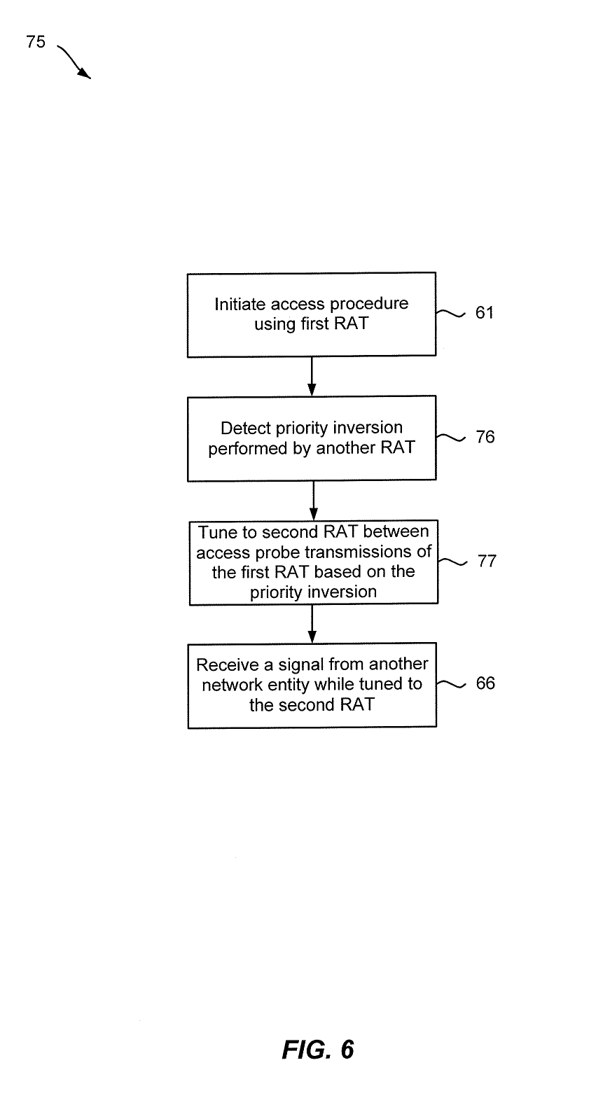

FIG. 6 depicts another example method 75 for performing strategic tune-away to receive signals in a second RAT during an access procedure of a first RAT. Method 75 includes, at Block 61, initiating an access procedure using the first RAT, as described above. UE 14 can include an access procedure component 22 for initiating the access procedure in this regard.

Method 75 also includes, at Block 76, detecting priority inversion performed by another RAT. Multi-RAT communicating component 20 can include a priority inversion detecting component 48 for detecting the priority inversion. For example, priority inversion detecting component 48 can detect one or more RATs increasing priority of current operations to obtain additional RF resources, and/or can receive an indication of such behavior from one or more other components of UE 14. This can indicate that less resources may be provided for transmitting access probes by access procedure component 22, which may mean multiple access probe sequences will be transmitted, and thus tune-away can be performed during one or more of the access probe sequences.

Method 75 thus includes, at Block 77, tuning to a second RAT for between access probe transmissions of the first RAT based on the priority inversion. For example, as described, strategic tune-away component 24 can tune to the second RAT for a determined duration based on an RTT delay following the access probe sequence, as described above. Method 75 also includes, at Block 66, receiving a signal from another network entity while tuned to the second RAT. As described, signal processing component 26 can be configured to receive signals from network entity 13 using the second RAT during the tune-away.

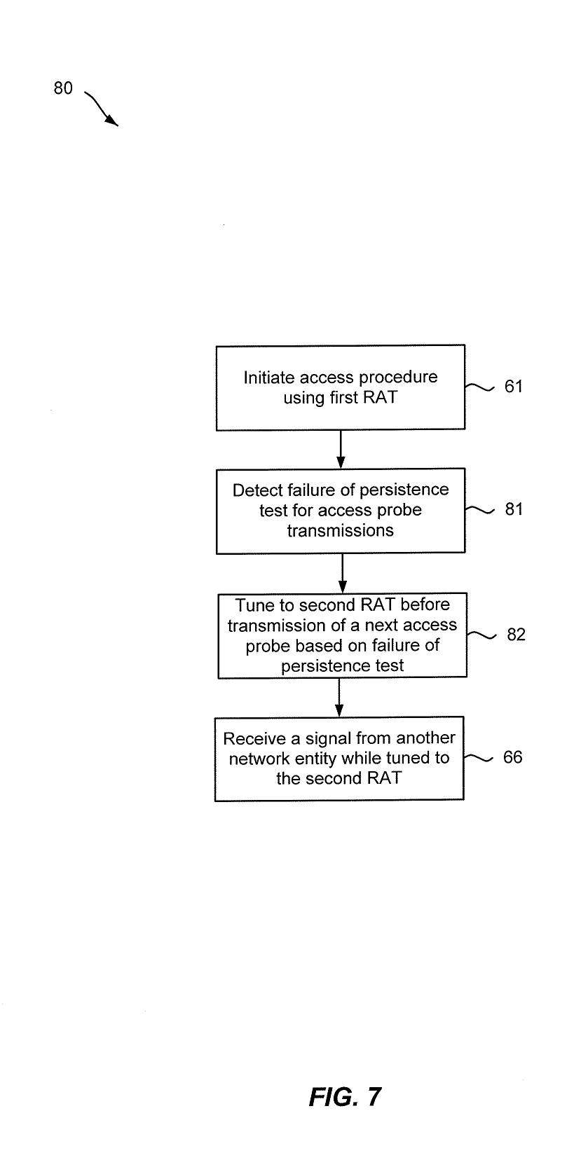

FIG. 7 depicts another example method 80 for performing strategic tune-away to receive signals in a second RAT during an access procedure of a first RAT. Method 80 includes, at Block 61, initiating an access procedure using the first RAT, as described above. UE 14 can include an access procedure component 22 for initiating the access procedure in this regard.

Method 80 also includes, at Block 81, detecting failure of a persistence test for access probe transmissions. Multi-RAT communicating component 20 can include a persistence test failure detecting component 50 for detecting failure of the persistence test. For example, a persistence test is performed between a UE and network entity before transmitting an access probe sequence, in some systems, to detect whether other probes are transmitting when the access probe sequence is to initiate. These other access probes may interfere with an access probe sequence from the UE, and the persistence test may fail in this case and/or when a threshold number of other probes are detected. Thus, persistence test failure detecting component 50 can determine if an indication of failure of the persistence test (e.g., backoff test) is received by access procedure component 22 and/or can otherwise detect the failure based at least in part on receiving a failure indication from network entity 12. This can indicate that the access procedure is not being performed (at least not for a period of time), and thus tune-away can be performed at least until the next access procedure is to be initiated by access procedure component 22. This period of time from failure of the persistence test until the access procedure can again be attempted can similarly be preconfigured or otherwise provisioned to UE 14.

Method 80 thus includes, at Block 82, tuning to a second RAT before transmission of a next access probe based on failure of the persistence test. For example, as described, strategic tune-away component 24 can tune to the second RAT for a determined duration during at least a portion of the period of time from failure of the persistence test until the access procedure can again be attempted. As described, strategic tune-away component 24 can compute the duration to be this period of time, a fraction of the period of time, and/or the like. Moreover, the period of time may be determined from a preconfigured or provisioned value, etc. Method 80 also includes, at Block 66, receiving a signal from another network entity while tuned to the second RAT. As described, signal processing component 26 can be configured to receive signals from network entity 13 using the second RAT during the tune-away.

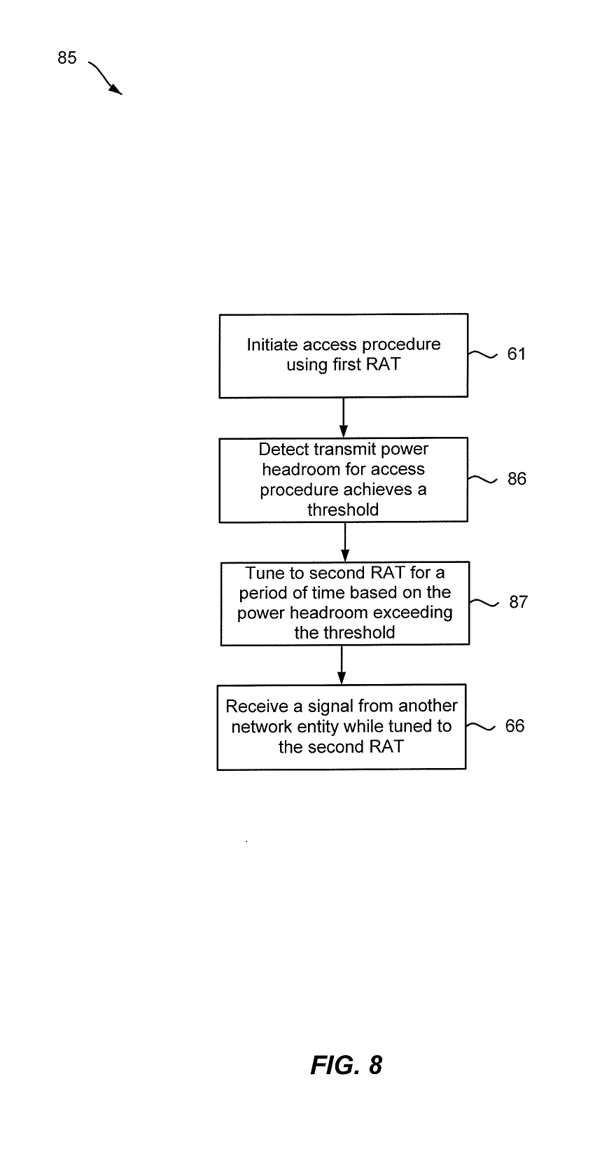

FIG. 8 depicts another example method 85 for performing strategic tune-away to receive signals in a second RAT during an access procedure of a first RAT. Method 85 includes, at Block 61, initiating an access procedure using the first RAT, as described above. UE 14 can include an access procedure component 22 for initiating the access procedure in this regard.

Method 85 also includes, at Block 86, detecting transmit power headroom for the access procedure achieves a threshold. Multi-RAT communicating component 20 can include a power headroom detecting component 52 for detecting whether the power headroom achieves the threshold. For example, where the power headroom achieves the threshold, this can indicate that the uplink is attenuated for the first RAT, and hence transmit power is increased. This can, in turn, indicate that the first RAT is subject to poor channel conditions, in which case strategic tune-away to the second RAT can occur to at least improve communications at the second RAT.

Method 85 thus includes, at Block 87, tuning to a second RAT for a period of time based on the power headroom exceeding the threshold. For example, as described, strategic tune-away component 24 can tune to the second RAT during the period of time. The period of time can be predefined or otherwise provisioned to the UE 14, and strategic tune-away component 24 can compute a duration for tune-away based on this period of time, as fraction of the period of time, and/or the like. In another example, power headroom detecting component 52 can continue to verify the power headroom, and strategic tune-away component 24 can tune back to the first RAT where the power headroom is lowered below the threshold. Method 85 also includes, at Block 66, receiving a signal from another network entity while tuned to the second RAT. As described, signal processing component 26 can be configured to receive signals from network entity 13 using the second RAT during the tune-away.

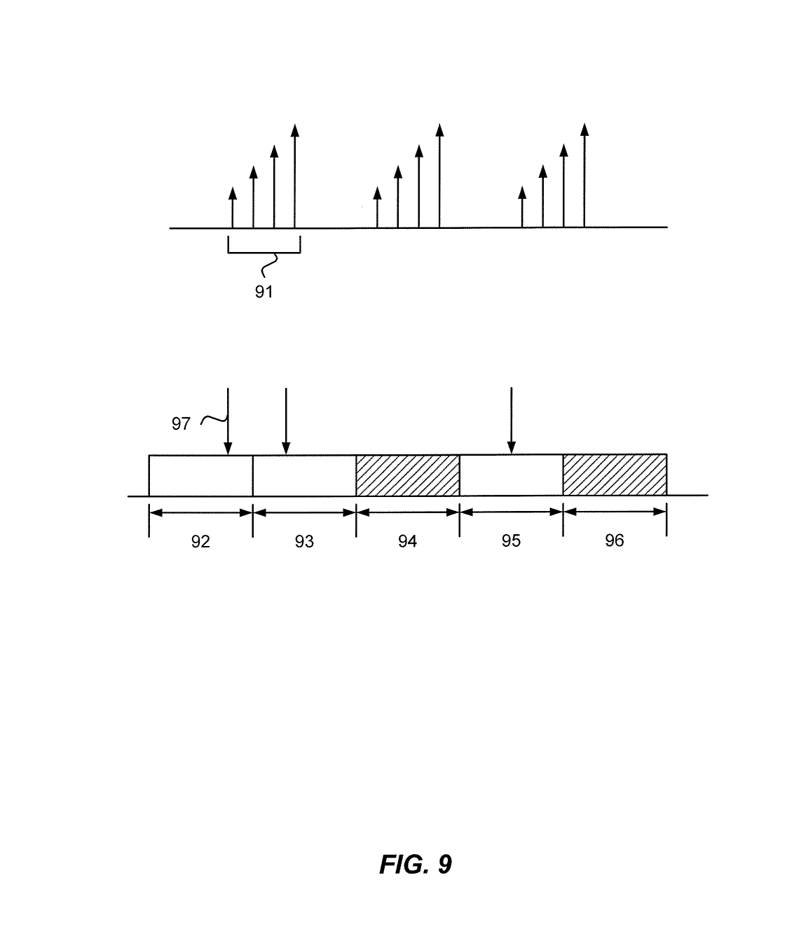

FIG. 9 illustrates an example illustration of access probe sequences, such as access probe sequence 91, which include a plurality of access probes transmitted at increasing power, as well as a plurality of time intervals 92, 93, 94, 95, 96 that are part of an access procedure described herein. The time intervals 92, 93, 94, 95, 96 can correspond to a single access probe sequence 91. In time interval 92, one or more access probes are transmitted (e.g., from a UE to a network entity to obtain a traffic channel, as described). Time interval 93 can be within the RTT delay, described above. In time interval 94, ACAck can be received. Time interval 95 can be within a delay between receiving ACAck and TCCAck, and in time interval 96, TCCAck can be received. In this regard, access procedure transmissions are expected in time intervals 94 and 96, and tune-away may not be performed during these time intervals to allow a UE to receive the access procedure communications. However, in time intervals 92, 93, and 95 of the access procedure, transmissions are not expected, and thus strategic tune-away can be performed, as described, for a duration during these time intervals. As depicted, in this regard, signals 97 can be received from another RAT when tuning away during time intervals 92, 93, and 95, such as paging signals.

FIG. 10 is a block diagram illustrating an example of a hardware implementation for an apparatus 100 employing a processing system 114. Apparatus 100 may be configured to include, for example, UE 14 (FIGS. 1 and 3), and one or more of multi-RAT communicating component 20 (FIGS. 1 and 3), components thereof, or other components of the UE 14, etc., as described above. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

In an aspect, processor 104, computer-readable medium 106, or a combination of both may be configured or otherwise specially programmed to perform the functionality of the multi-RAT communicating component 20 (FIGS. 1 and 3), components thereof, etc., as described herein.

The various concepts presented throughout this disclosure may be implemented across a broad variety of telecommunication systems, network architectures, and communication standards.

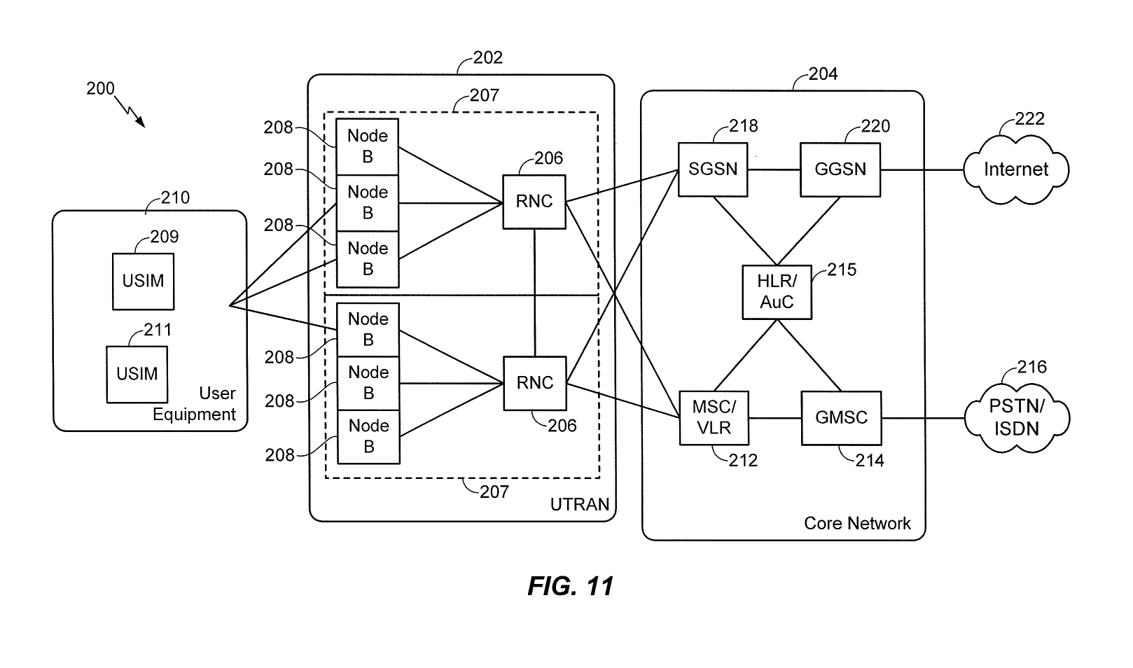

Referring to FIG. 11, by way of example and without limitation, the aspects of the present disclosure are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. UE 210 may be configured to include, for example, one or more of the multi-RAT communicating component 20 (FIGS. 1 and 3), components thereof, etc., as described above. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE 210 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In addition, with the Internet of Things/Everything becoming more prevalent in the future, it would be beneficial to include other types of devices as a mobile apparatus or UE and not just the traditional mobile device, such as a watch, a personal digital assistant, a personal monitoring device, a machine monitoring device, a machine to machine communication device, etc. In a UMTS system, the UE 210 may further include one or more universal subscriber identity modules (USIM) 209, 211, which can include user subscription information to one or more networks. As described, in an example, the networks can operate using different RATs, and thus UE 210 can communicate with the networks based on a corresponding USIM 209, 211 and RAT. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate, or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

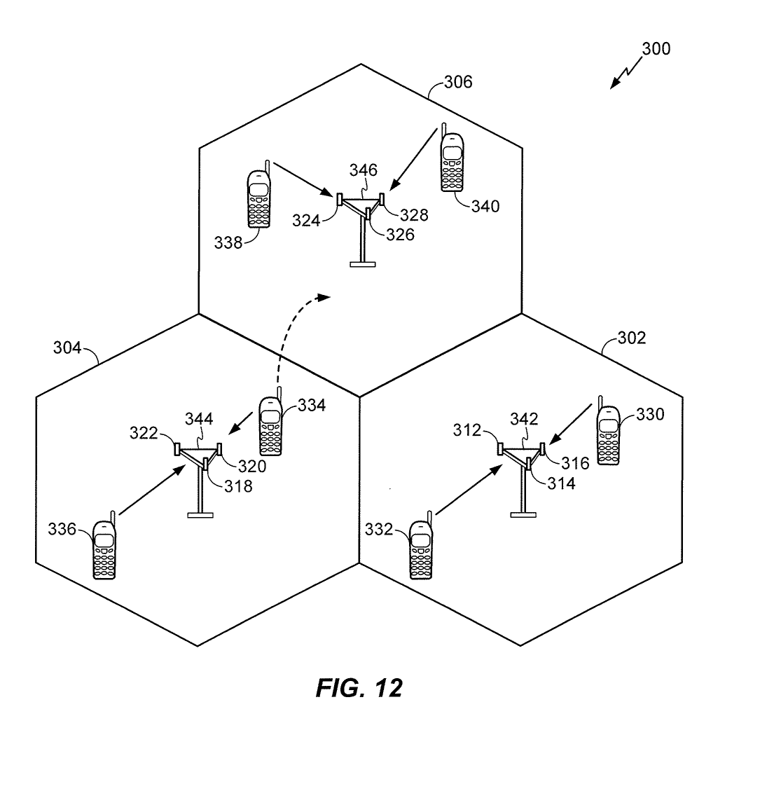

Referring to FIG. 12, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 11) for all the UEs 330, 332, 334, 336, 338, 340 in the respective cells 302, 304, and 306. Node Bs 342, 344, 346 and UEs 330, 332, 334, 336, 338, 340 respectively may be configured to include, for example, one or more of the multi-RAT communicating component 20 (FIGS. 1 and 3), components thereof, etc., as described above.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 11), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

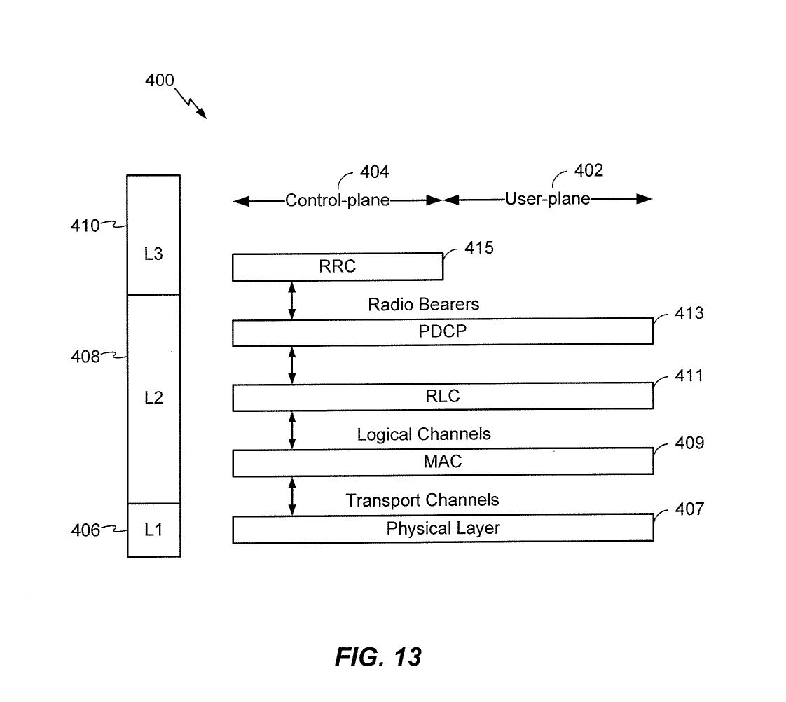

The radio protocol architecture may take on various forms depending on the particular application. An example for an HSPA system will now be presented with reference to FIG. 13.

FIG. 13 is a conceptual diagram illustrating an example of the radio protocol architecture 400 for the user plane 402 and the control plane 404 of a user equipment (UE) or node B/base station. For example, architecture 400 may be included in a network entity and/or UE such as an entity within wireless network (e.g. network entity 12/13) and/or UE 14 (FIGS. 1 and 3). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

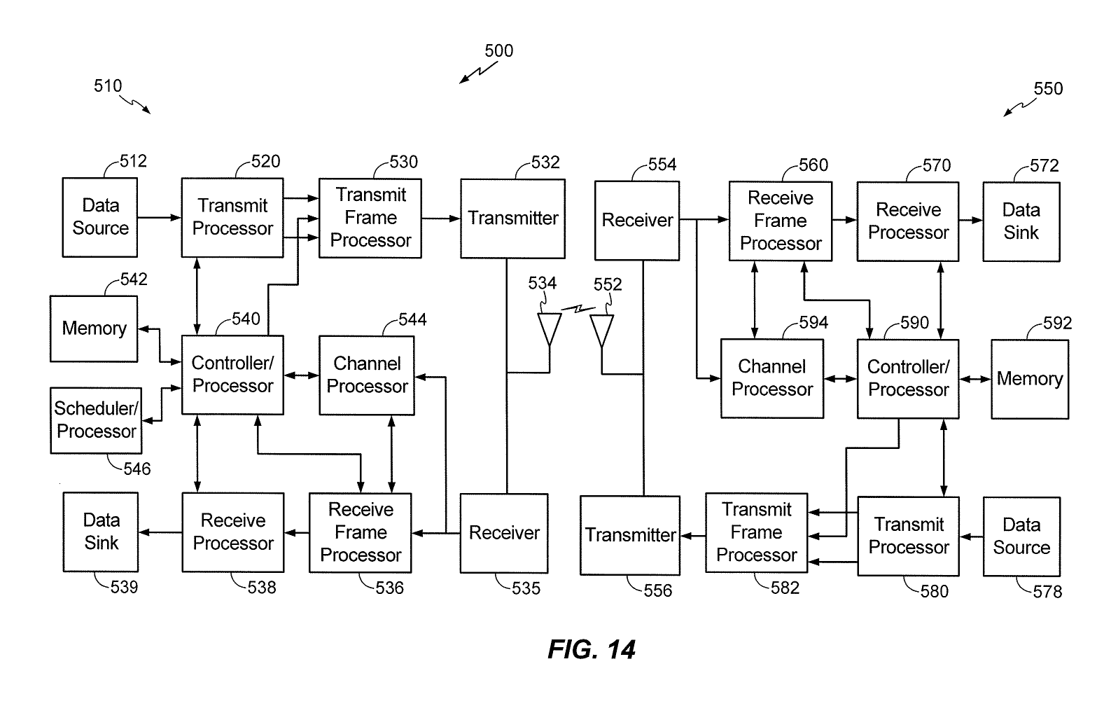

FIG. 14 is a block diagram of a communication system 500 including a Node B 510 in communication with a UE 550, where Node B 510 may be an entity within wireless network (e.g., network entity 12/13 of FIG. 1) and the UE 550 may be UE 14, including one or more of the multi-RAT communicating component 20 (FIGS. 1 and 3), components thereof, etc., according to the aspects described in FIGS. 1 and 3. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements, such as components, modules, etc. described herein, may be implemented with a “processing system” or processor (FIG. 10) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106 (FIG. 10). The computer-readable medium 106 (FIG. 10) may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of pre-AIA 35 U.S.C. §112, sixth paragraph, or post-AIA 35 U.S.C. §112(f), unless the element is expressly recited using the phrase “means for” or, in the case of a method claim, the element is recited using the phrase “step for.”

What is claimed is:

1. A method of wireless communication of a user equipment (UE), comprising:
initiating an access procedure for a first radio access technology (RAT);
tuning a receiver to a second RAT for a duration during the access procedure for the first RAT;
receiving a paging signal via the second RAT during the duration; and
tuning the receiver to the first RAT following the duration to continue the access procedure for the first RAT.

2. The method of claim 1, wherein tuning the receiver to the second RAT is based at least in part on determining occurrence of an access probe transmission as part of the access procedure.

3. The method of claim 2, further comprising:
determining a round-trip time (RTT) delay for communicating with a network entity; and
determining the duration for tuning the receiver to the second RAT based at least in part on the RTT delay.

4. The method of claim 2, wherein tuning the receiver to the second RAT is further based at least in part on at least one of determining that channel conditions with a network entity using the first RAT do not achieve a threshold, determining that a maximum number of access probe transmissions or access probe transmission sequences has not been achieved by the access probe transmission, and detecting receipt of an access channel acknowledgement message in response to an access probe as part of the access procedure.

5. The method of claim 4, further comprising determining the duration for tuning the receiver based at least in part on a provisioned time between receiving the access channel acknowledgement message and a traffic channel complete acknowledgement message.

6. The method of claim 1, wherein tuning the receiver to the second RAT is based at least in part on detecting a priority inversion of one or more RATs.

7. The method of claim 6, further comprising determining the duration for tuning the receiver based at least in part on a provisioned time related to detecting the priority inversion or until the priority inversion is complete.

8. The method of claim 1, wherein tuning the receiver to the second RAT is based at least in part on detecting failure of a persistence test as part of the access procedure.

9. The method of claim 8, further comprising determining the duration for tuning the receiver based at least in part on a provisioned time related to a period of time between the failure of the persistence test and a next transmission of another access probe.

10. The method of claim 1, wherein tuning the receiver to the second RAT is based at least in part on detecting that a power headroom related to an uplink achieves a threshold.

11. The method of claim 10, further comprising determining the duration for tuning the receiver based at least in part on a provisioned time related to detecting that the power headroom achieves the threshold or until the power headroom does not achieve the threshold.

12. The method of claim 1, further comprising increasing a priority for communicating using the first RAT before initiating the access procedure.

13. The method of claim 1, wherein the access procedure corresponds to a procedure for transitioning to an ACCESS state in a high data rate (HDR) network.

14. An apparatus for wireless communication of a user equipment (UE), comprising:
a multi-radio access technology (RAT) communicating circuit, comprising:
an access procedure circuit configured for initiating an access procedure for a first RAT;
a strategic tune-away circuit configured for tuning a receiver to a second RAT for a duration during the access procedure for the first RAT; and
a signal processing circuit configured for receiving a paging signal via the second RAT during the duration,
wherein the strategic tune-away circuit is further configured for tuning the receiver to the first RAT following the duration to continue the access procedure for the first RAT.

15. The apparatus of claim 14, further comprising an access procedure detecting circuit configured for determining occurrence of an access probe transmission, wherein the strategic tune-away circuit is configured for tuning the receiver to the second RAT based at least in part on the detected access probe transmission.

16. The apparatus of claim 15, wherein the strategic tune-away circuit is further configured for:
determining a round trip time (RTT) delay for communicating with a network entity; and
determining the duration for tuning the receiver to the second RAT based at least in part on the RTT delay.

17. The apparatus of claim 15, further comprising a channel condition determining circuit configured for determining channel conditions with a network entity using the first RAT, wherein the strategic tune-away circuit is configured for tuning the receiver to the second RAT further based at least in part on determining that the channel conditions do not achieve a threshold.

18. The apparatus of claim 15, wherein the access procedure detecting circuit is further configured for determining a number of access probe transmissions or access probe transmission sequences, and wherein the strategic tune-away circuit is configured for tuning the receiver to the second RAT further based at least in part on determining that the number of access probe transmissions has not achieved a maximum number of access probe transmissions or access probe transmission sequences.

19. The apparatus of claim 14, further comprising an access procedure detecting circuit configured for detecting receipt of an access channel acknowledgement message in response to an access probe, wherein the strategic tune-away circuit is configured for tuning the receiver to the second RAT based at least in part on detecting receipt of the access channel acknowledgement message.

20. The apparatus of claim 19, further comprising a channel condition determining circuit configured for determining channel conditions with a network entity using the first RAT, wherein the strategic tune-away circuit is configured for tuning the receiver to the second RAT further based at least in part on determining that the channel conditions do not achieve a threshold.

21. The apparatus of claim 19, wherein the strategic tune-away circuit is further configured for determining the duration for tuning the receiver based at least in part on a provisioned time between receiving the access channel acknowledgement message and a traffic channel complete acknowledgement message.

22. The apparatus of claim 14, further comprising a priority inversion detecting circuit configured for detecting a priority inversion of one or more RATs, wherein the strategic tune-away circuit is configured for tuning the receiver to the second RAT based at least in part on detecting the priority inversion.

23. The apparatus of claim 22, wherein the strategic tune-away circuit is further configured for determining the duration for tuning the receiver based at least in part on a provisioned time related to detecting the priority inversion or until the priority inversion is complete.

24. The apparatus of claim 14, further comprising a persistence test failure detecting circuit configured for detecting failure of a persistence test as part of the access procedure, wherein the strategic tune-away circuit is configured for tuning the receiver to the second RAT is based at least in part on detecting the failure of the persistence test.

25. The apparatus of claim 24, wherein the strategic tune-away circuit is further configured for determining the duration for tuning the receiver based at least in part on a provisioned time related to a period of time between the failure of the persistence test and a next transmission of another access probe.

26. The apparatus of claim 14, further comprising a power headroom detecting circuit configured for detecting that a power headroom related to an uplink achieves a threshold, wherein the strategic tune-away circuit is configured for tuning the receiver to the second RAT based at least in part on the power headroom.

27. The apparatus of claim 26, wherein the strategic tune-away circuit is further configured for determining the duration for tuning the receiver based at least in part on a provisioned time related to detecting that the power headroom achieves the threshold or until the power headroom does not achieve the threshold.

28. The apparatus of claim 14, wherein the multi-RAT communicating circuit is configured for increasing a priority for communicating using the first RAT before initiating the access procedure.

29. The apparatus of claim 14, wherein the access procedure corresponds to a procedure for transitioning to an ACCESS state in a high data rate (HDR) network.

30. A computer program product, stored on a non-transitory computer readable medium, for wireless communication of a user equipment (UE), comprising:
code for causing at least one computer to initiate an access procedure for a first radio access technology (RAT);
code for causing the at least one computer to tune a receiver to a second RAT for a duration during the access procedure for the first RAT; and
code for causing the at least one computer to receive a paging signal via the second RAT during the duration,
wherein the code for causing the at least one computer to tune tunes the receiver to the first RAT following the duration to continue the access procedure for the first RAT.

31. The computer program product of claim 30, wherein the code for causing the at least one computer to tune tunes the receiver to the second RAT based at least in part on determining occurrence of an access probe transmission as part of the access procedure.

32. The computer program product of claim 31, further comprising:
code for causing the at least one computer to determine a round trip time (RTT) delay for communicating with a network entity; and
code for causing the at least one computer to determine the duration for tuning the receiver to the second RAT based at least in part on the RTT delay.

33. The computer program product of claim 31, wherein the code for causing the at least one computer to tune tunes the receiver to the second RAT based at least in part on detecting receipt of an access channel acknowledgement message in response to an access probe as part of the access procedure.

34. The computer program product of claim 30, wherein the code for causing the at least one computer to tune tunes the receiver to the second RAT based at least in part on at least one of detecting priority inversion of one or more RATs, detecting failure of a persistence test as part of the access procedure and detecting that a power headroom related to an uplink achieves a threshold.

35. The computer program product of claim 30, further comprising code for causing the at least one computer to increase a priority for communicating using the first RAT before initiating the access procedure.

36. The computer program product of claim 30, wherein the access procedure corresponds to a procedure for transitioning to an ACCESS state in a high data rate (HDR) network.
